(19) United States
(12) Patent Application Publication
(10) Pub. No.: US 2025/0366416 A1
(43) Pub. Date: Dec. 4, 2025

(54) IRRIGATION SITE SHARING AND TRANSFERRING

(71) Applicant: Rain Bird Corporation, Azusa, CA (US)

(72) Inventors: David E. Colombo, San Diego, CA (US); Neil G. Krinitsky, Tucson, AZ (US); Sean Fayazi-Azad, Tucson, AZ (US)

(21) Appl. No.: 19/221,272

(22) Filed: May 28, 2025

Related U.S. Application Data
(60) Provisional application No. 63/652,581, filed on May 28, 2024.

(51) Int. Cl. A01G 25/16; G06F 16/22; G06F 21/60

(52) U.S. Cl. CPC A01G 25/16; G06F 16/2282; G06F 21/604

(57) ABSTRACT

In some embodiments, irrigation control apparatuses, systems, and methods are provided herein. In some embodiments, a system includes a server having a control circuit; a database; and a central control irrigation application configured to be executed by the control circuit, wherein when executed by the server, the application: receives, from a first user associated with a first account, a request to change rights for an irrigation site with respect to a second user associated with a second account, wherein the request specifies a code that corresponds to the second account; and edits an asset table stored in the database to associate a unique identifier associated with the second account and corresponding to the code with the group of one or more irrigation controllers in the asset table to allow the second user to access and edit the at least one programming parameter of the group via a user interface.

### CROSS-REFERENCE TO RELATED APPLICATIONS

This application claims the benefit of U.S. Provisional Application No. 63/652,581 filed May 28, 2024, which is incorporated herein by reference in its entirety.

### TECHNICAL FIELD

This disclosure related generally to irrigation control and, in particular, to irrigation control systems with user interfaces for monitoring and controlling irrigation.

### BACKGROUND

In a typical irrigation control system, a computer executing irrigation control software and/or a dedicated electronic irrigation controller store and execute irrigation schedules that control watering components in a landscape to apply watering.

### BRIEF DESCRIPTION OF DRAWINGS

Disclosed herein are embodiments of systems, apparatuses and methods pertaining to an irrigation system that allows users to change access rights with respect to other users, such as sharing and transferring access rights. This description includes drawings, wherein:

FIG. 1 is an exemplary irrigation control system in accordance with some embodiments.

FIG. 2 is a signaling flow diagram for one user to share an irrigation site with another user in accordance with several embodiments.

FIGS. 3A-3F are tables maintained in a database of a server in accordance with some embodiments.

FIGS. 4-8 are example user interfaces illustrating the sharing of an irrigation site in accordance with several embodiments.

FIG. 9 is a signaling flow diagram for one user to transfer an irrigation site to another user in accordance with several embodiments.

FIGS. 10-17 are example user interfaces illustrating the transferring of an irrigation site in accordance with some embodiments.

FIG. 18 is a flow diagram illustrating methods of sharing and/or transferring irrigation sites in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to allow users to change access rights with respect to other users. In some embodiments, an irrigation control system and method of using the system are provided, where the system includes: a server having a control circuit; a database; and a central control irrigation application to manage watering of at least plant life by a plurality of sprinklers at a landscape via irrigation valves and to be executed by a control circuit. And when executed by the control circuit of the server, the central control irrigation application: receives, from a first user associated with a first account, a request to change rights for an irrigation site with respect to a second user associated with a second account, wherein the first account and the second account are registered with the central control irrigation application, wherein the request specifies a code that corresponds to the second account, wherein the irrigation site comprises a group of one or more irrigation controllers associated with the first account and that the first user can access and edit at least one programming parameter of the group of the one or more irrigation controllers via a first user interface, wherein each irrigation controller comprises is coupled to one or more irrigation valves actuatable to control fluid flow to at least one of the plurality of sprinklers; and edits an asset table stored in the database to associate a unique identifier associated with the second account and corresponding to the code with the group of the one or more irrigation controllers in the asset table to allow the second user to access and edit the at least one programming parameter of the group of the one or more irrigation controllers via a second user interface.

In some embodiments, a method for use with an irrigation system includes the steps: receiving, at a central control irrigation application that manages watering of at least plant life by a plurality of sprinklers at a landscape via irrigation valves and is executable by a control circuit of a server, from a first user associated with a first account, a request to change rights for an irrigation site with respect to a second user associated with a second account, wherein the first account and the second account are registered with the central control irrigation application, wherein the request specifies a code that corresponds to the second account, wherein the irrigation site comprises a group of one or more irrigation controllers associated with the first account and that the first user can access and edit at least one programming parameter of the group of the one or more irrigation controllers via a first user interface, wherein each irrigation controller comprises is coupled to one or more irrigation valves actuatable to control fluid flow to at least one of the plurality of sprinklers. Alternatively or in addition, the method includes editing, by the central control irrigation application, an asset table stored in a database to associate a unique identifier associated with the second account and corresponding to the code with the group of the one or more irrigation controllers in the asset table to allow, by the central control irrigation application, the second user to access and edit the at least one programming parameter of the group of the one or more irrigation controllers via a second user interface.

In some embodiments, an irrigation control system comprises an irrigation management application for use in monitoring and/or controlling irrigation of at least one irrigation site including one or more irrigation controllers, wherein the irrigation management application is configured to be executed by an electronic device including a control circuit, and a memory, wherein the irrigation management application is stored in the memory. When executed by the control circuit, the irrigation management application: causes a first user interface to be displayed on a display to a first user associated with a first account registered with a central control irrigation application at a server, the first user interface providing a change rights request interface including an irrigation site selection field and a code entry field to the first user, wherein the at least one irrigation site comprises a group of one or more irrigation controllers associated with the first account and that the first user can access and edit at least one programming parameter of the group of the one or more irrigation controllers via the first user interface, wherein each irrigation controller comprises is coupled to one or more irrigation valves actuatable to control fluid flow to at least one of a plurality of sprinklers; and transmits a request to change rights to the central control irrigation application at the server, the request to change rights including an irrigation site input by the first user to the irrigation site selection field and a code that corresponds to a second account that is also registered with the central control irrigation application and that corresponds to a second user, wherein the request to change rights will allow the second user to access and edit the at least one programming parameter of the group of the one or more irrigation controllers via a second user interface.

And in some embodiments, an irrigation control system comprises a central control irrigation application for use in monitoring and/or controlling irrigation of at least one irrigation site including one or more irrigation controllers, wherein the central control irrigation application is stored in a memory and configured to be executed by a control circuit of a server. When executed by the control circuit, the central control irrigation application: causes a first user interface to be displayed on a display of a first electronic device to a first user associated with a first account registered with the central control irrigation application at the server, the first user interface providing a change rights request interface including an irrigation site selection field and a code entry field to the first user, wherein the at least one irrigation site comprises a group of one or more irrigation controllers associated with the first account and that the first user can access and edit at least one programming parameter of the group of the one or more irrigation controllers via the first user interface, wherein each irrigation controller comprises is coupled to one or more irrigation valves actuatable to control fluid flow to at least one of a plurality of sprinklers; allows the first user interface to transmit a request to change rights to the central control irrigation application at the server, the request to change rights including an irrigation site input by the first user to the irrigation site selection field and a code that corresponds to a second account that is also registered with the central control irrigation application and that corresponds to a second user; and edits an asset table stored in a database to associate a unique identifier associated with the second account and corresponding to the code with the group of the one or more irrigation controllers in the asset table to allow the second user to access and edit the at least one programming parameter of the group of the one or more irrigation controllers via a second user interface.

The following description is not to be taken in a limiting sense but is made merely for the purpose of describing the general principles of exemplary embodiments. Reference throughout this specification to “one embodiment,” “an embodiment,” “some embodiments,” “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

In a central irrigation control system, irrigation scheduling is often programmed and stored at and controlled by a central control system. The central irrigation control system may be in the form of a dedicated computer having central control software installed thereon. Users can directly and/or remotely access the computer to define watering schedules, set up weather adjustments, etc. for irrigation devices located at an irrigation site. At a given irrigation site, there is typically one or more satellite irrigation controllers that receive irrigation schedules or commands from the computer, and then in turn, send control signals to irrigation valves (or stations) that when opened, cause water to flow one or more sprinklers. In some cases, the central control software function is implemented in a server, e.g., a cloud server accessible by multiple remotely located users. The server can allow different users to define and control irrigation at their different independent sites. In some cases, users register with the server and their data, control parameters, etc. are stored at or by the server. An example of a commercial cloud based central control system is IQ-Cloud offered by Rain Bird Corporation of Azusa, California.

In some cases, a first user or entity that owns and controls irrigation controllers at one or more locations may wish to share access to one or more of their controllers with a second user or entity. This sharing could allow the other user to assist with entering schedules, making adjustments, or troubleshooting problems in the system. The second user could be an employee, spouse, friend, neighbor, and so on. The second user also could be a hired landscaper or contractor to help set up an irrigation system at a location. The second user could also be a support person of the company providing the central control function. Thus, in some systems, there is a need for a given registered user or entity to share one or more of their controllers to guest users. Further, there can also be a need to transfer one or more controllers from one user to another user.

### Sharing Sites

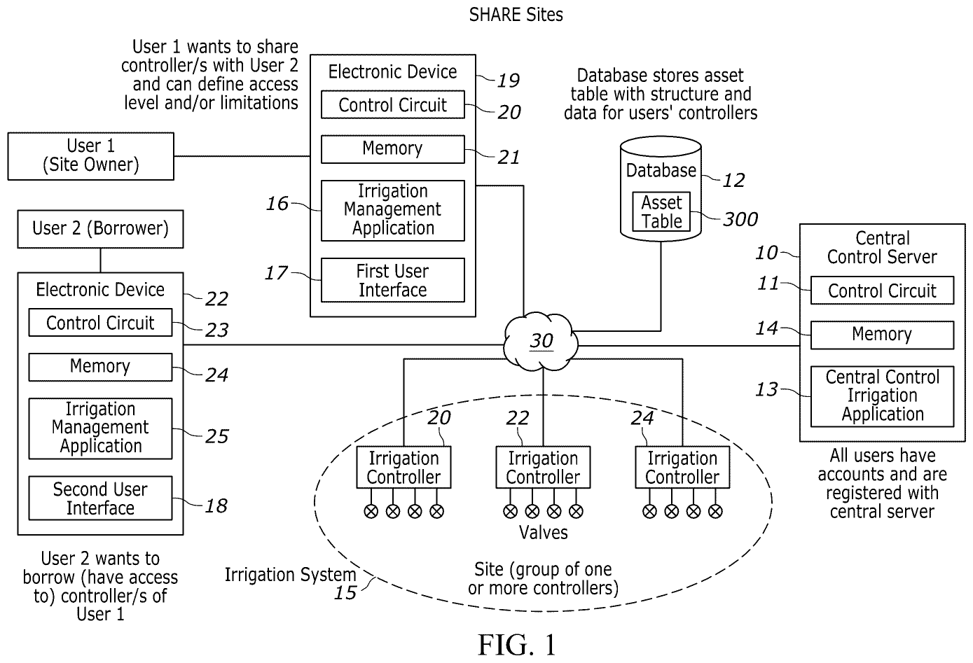

Referring to FIG. 1, a server 10 executes central control software functionality for multiple users, all of whom have or are associated with accounts with the server 10. For example, the server 10 is a computer-based device having a programmable processor (e.g., a control circuit 11), a memory 14 and a central control irrigation application 13 stored in the memory 14 and executable by the control circuit 11 to provide central irrigation control functionality. User 1 is an owner/user of an irrigation system 15 including at least one irrigation controller 20. In some embodiments, a collection of one or more irrigation controllers is referred to as a “site”. In this context, a “site” is not necessarily used to refer to a given location or property. User 1 is registered and has or is associated with an account with the server 10, e.g., the user is registered with the server and accesses the server, e.g., with a username/email/phone number and/or password. The server 10 stores and maintains all scheduling for User 1's controllers 20, 22, 24 in a database 12. It is understood that while three irrigation controllers 20, 22, 24 are illustrated in FIG. 1, there may be any number of irrigation controllers at one or more locations that are associated with a given user. In some embodiments, User 1 would like to share access to view, edit, set up, troubleshoot any schedules or parameters for one or more of the controllers 20, 22, 24 with User 2. In order to do so, in some embodiments, User 2 needs to also be registered and have or be associated with an account with the server 10. User 2 can be an employee, spouse, friend, neighbor, landscaper, contractor, account support person, etc.

In some embodiments, the users (e.g., User 1 and User 2) that are registered with server 10 access the server via a user interface displayed by an irrigation management application (e.g., irrigation management application 16 and irrigation management application 25) executed by a control circuit (e.g., control circuit 20 and control circuit 23) of an electronic device or user device (e.g., electronic device 19 and electronic device 22). In some aspects, the irrigation management application is downloaded to the electronic device and stored in a memory (e.g., memory 21 and memory 24) local to the electronic device. In some embodiments, the irrigation management application is stored in a cloud accessible anywhere from any electronic device available to the user, e.g., using browser or display functionality of the electronic device. In such embodiments, the irrigation management application is individually executed and separately accessible to each user. The irrigation management application is used for monitoring and/or controlling irrigation of at least one irrigation site including one or more irrigation controllers (e.g., irrigation controller 20, irrigation controller 22, and irrigation controller 24).

In some embodiments, the server 10 is directly or indirectly coupled to the database 12 that stores an asset table 300 indicating the structure of the owner's sites, controllers, and all child entities such as stations, programs, sensors, etc. A network 30 can communicationally connect the user devices (e.g., electronic device 19 and electronic device 22), the server 10, the database 12 and the controllers 20, 22, 24. For example, the network 30 may include the Internet and/or any local area and/or wide area wired and/or wireless communication network capable of communicatively connecting electronic devices (e.g., user devices, communication devices, network devices, storage device, to name a few) in a network architecture.

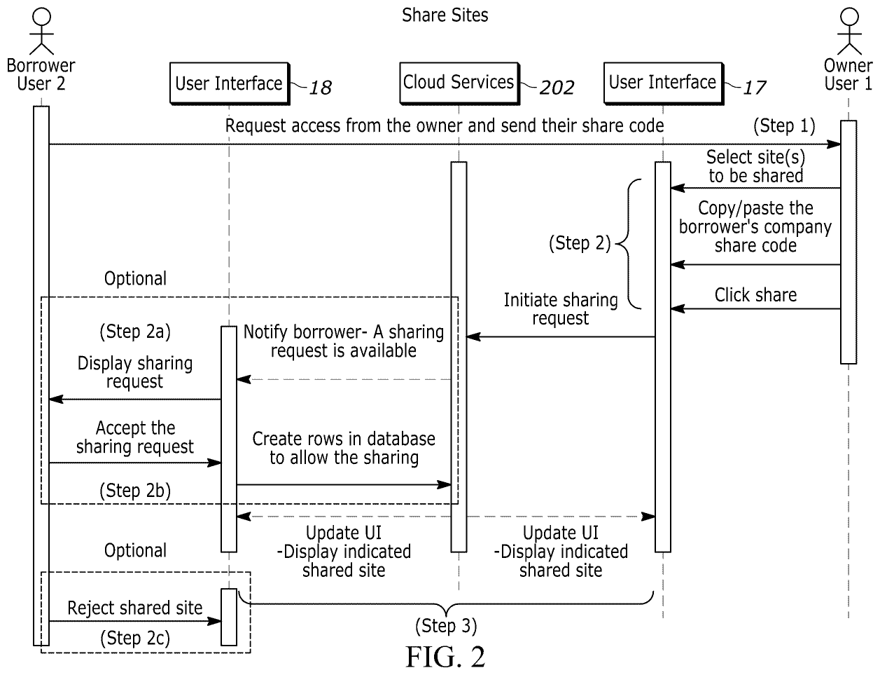

Referring to FIG. 2, in some embodiments, for User 1 (owner) to share a site (i.e., group of one or more controllers) with User 2 (borrowing user), User 2 first sends a unique code which is in some cases referred to as a share code (e.g., numeric, alphabetic, or alphanumeric code corresponding to an account identification, and/or a unique code, to name a few) to User 1 (Step 1). In some cases, User 2 causes an email to be sent to User 1. User 2's unique share code is specific to the account of User 2 and is used to identify the user account associated with User 2 or to identify User 2. When User 1 receives the share code, User 1 determines which site/s to share with User 2 and inputs the share code for those site/s to be shared (Step 2) in a central control irrigation application 13. For example, the owner selects irrigation controllers 20, 22, and 24 to share with User 2, pastes the share code of User 2 into the user interface and selects/clicks to share. The central control irrigation application 13 receives the share code allowing User 1 to change rights for an irrigation site with respect to User 2. In the illustration of FIG. 2, cloud services 202 represent the connection to the central control server 10 and central control irrigation application 13. User 1 is associated with a first account and User 2 is associated a second account. The first account and the second account are registered with the central control irrigation application 13. In some embodiments, the share code includes a request specifying a code (e.g., an alphanumeric code described above) that corresponds to the second account. The irrigation site may include a group of one or more irrigation controllers 20, 22, 24 (and/or any number of other irrigation controllers) associated with the first account and that User 1 can access and edit at least one programming parameter of the group of the one or more irrigation controllers via a first user interface 17 displayed by and/or provided to the first user via the electronic device 19. In some embodiments, user interfaces, such as the first user interface 17 and a second user interface 18, may be visually, audibly, and/or haptically displayed by and/or provided to a user by a smartphone, a laptop, a desktop, and/or any electronic devices capable of operatively communicating with the server 10, the control circuit 11, and/or the central control irrigation application 13. In some embodiments, the first user interface 17 and/or the second user interface 18 may be provided by the irrigation management application 16 and/or the irrigation management application 25 which is in communication with the central control irrigation application 13 and which renders a display capable of interfacing between a user (e.g., User 1 and User 2) and the central control irrigation application 13 to operate an irrigation system 15 or any one or more irrigation controllers 20, 22, 24 of the irrigation system 15. In some embodiments, the first user interface 17 and/or the second user interface 18 may be transmitted from the central control irrigation application 13 with instructions for an application (e.g., operating system, browser application, etc.) of the electronic device to render the respective user interface.

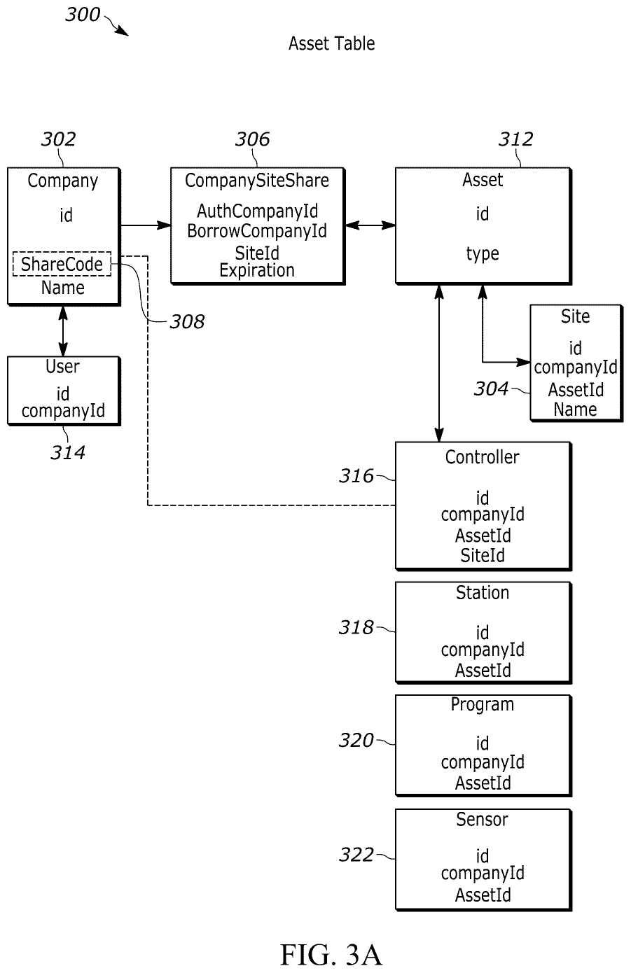

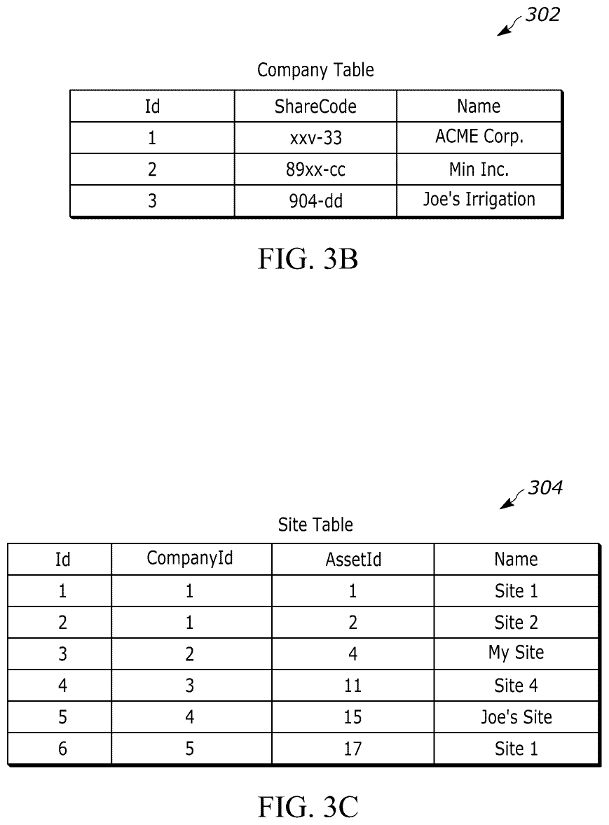

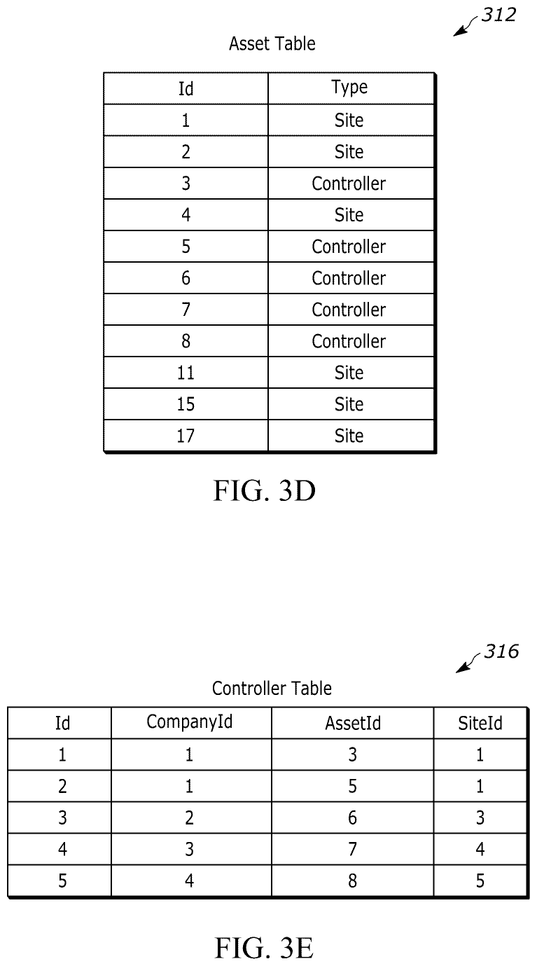

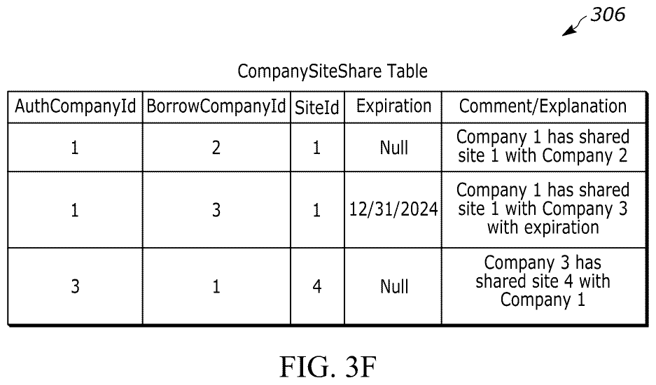

At this point (i.e., after the share code for those site/s to be shared is received by the central control irrigation application 13 via the cloud services 202), the cloud server 10 is updated and access to the shared site/s is now provided to User 2, and User 2 can select the shared site/s from their account using the second user interface 18. As shown in FIG. 2, the user interfaces (e.g., the first user interface 17 and the second user interface 18) are updated to indicate to User 1 that a site being shared and to indicate to User 2 that the site is being borrowed (Step 3). For example, after receiving the share code from User 1, the central control irrigation application 13 edits an asset table 300 stored in the database 12 to associate a unique identifier associated with the second account and corresponding to the code with add the share code to the group of the one or more irrigation controllers 20, 22, 24 in the asset table 300. FIGS. 3A-3F provide an example asset table that is edited to provide this access in accordance with some embodiments. In some embodiments, after the asset table 300 is updated, the central control irrigation application 13 allows the user 2 to access and edit the at least one programming parameter of the group of the one or more irrigation controllers 20, 22, 24 via the second user interface 18.

In some embodiments, optional additional steps after Step 2 and before Step 3 include that User 2 is notified of the site/s being shared (Step 2a) and User 2 confirms or accepts the request (Step 2b). For example, after granting user 2 access and ability to edit at least one programming parameter of the group of the one or more irrigation controllers 20, 22, 24, the central control irrigation application 13 sends a notification to User 2 and/or displays the sharing request to the second user interface 18. Alternatively or in addition, User 2 may accept the sharing request (Step 2b). In some embodiments, the central control irrigation application 13 may create rows in the asset table 300 of the database 12. In some embodiments, the created row/s is/are associated with the account associated with User 2 (e.g., the newly created “default site” row shown in FIG. 17). Further, in some embodiments, User 2 may reject the sharing request (Step 2c), e.g., perhaps the request does not identify the correct irrigation controllers of the site and needs to be updated.

In some embodiments, when inputting the borrower's share code, User 1 can specify an expiration for the sharing and/or other limitations in User 2's ability to access and edit parameters of the site being shared. Further, in some embodiments, from the account associated with User 1, User 1 can revoke the sharing of the site/s even if not otherwise limited by an expiration. In some embodiments, User 1 can define the expiration in terms of time (such as expires in 1 month), by date (such as, expires on a given day), and/or by event (such as, expires after x number of views/edits, after occurrence of y watering events, etc.).

In some embodiments, borrowing users can do one or more of the following: provide a share code to an owner; accept/approve a shared site; view/update a shared site; create/read/update/delete (CRUD) all child objects of a shared site; and exit the sharing agreement. In some embodiments, a borrowing user cannot do one or more of the following: create/delete a site in another company (User 2 can't create or delete a site in User 1's account); all CRUD operations unrelated to the shared Site are blocked in the owners account (for example, you cannot Create/Read/Update/Delete Users, Company Data, or any data other than the Shared Site); view sites in another account unless it is shared with the borrower; share a borrowed site to another account; and move a borrowed site to another site accessible by the borrower.

In some embodiments, sites (i.e., groups of one or more controllers) are stored in the database 12, and when they are shared, they are not copied or cloned in any way. The owners and borrowers are viewing and editing and working with the exact same database objects. In some embodiments, when either an owner or borrower updates the data for a site, it is saved as the same object instance in the database 12, so all parties are always fully synchronized and see the exact same data. In some embodiments, there is no need to have any operations to keep data in sync, because everyone is editing the same row of data in the database 12.

In some embodiments, the database 12 permits certain objects to be shared across accounts, while still maintaining data integrity and ownership of the data. In some embodiments, this is accomplished by adding and maintaining an asset table 300 (see an example of such an asset table of FIG. 3A) into the database 12. In some embodiments, the asset table 300 classifies sites and controllers as assets of accounts, but also allowing assets to be shared to other accounts.

In an illustrative non-limiting example, the central control irrigation application 13 may receive a request from a first user (borrower, User 2 in FIG. 2) to change rights including a request to share the irrigation site with the second user (owner, User 1 in FIG. 2), such that the first user and the second user can both access and edit the at least one programming parameter of the group of the one or more irrigation controllers (e.g., irrigation controller 20, irrigation controller 22, and irrigation controller 24 of FIG. 1). Alternatively or in addition, the request to share the irrigation site with the second user may include data defining an end of the share period (e.g., expiration date shown in FIG. 7). In some embodiments, the request specifies a code including a share code as described herein that is unique to a second account (the account associated with the user requesting to share the irrigation site), and the share code corresponds to a unique account identifier assigned to the second account. In some embodiments, the code includes a series of characters that acts as a user-facing account identifier for the second account. In some embodiments, the code corresponds to a system-facing account identifier that corresponds to the second account. In some embodiments, the code does not include a user identification (user id), a name of the user, nor a password associated with the account.

FIGS. 3A-3F illustrate various tables, for example, maintained in the database 12 in accordance with some embodiments. FIG. 3A illustrates an embodiment of an asset table 300. In some embodiments, the asset table 300 is a many-to-many join table that allows the sharing of many assets between many companies (e.g., accounts, business and/or residential accounts and/or account identifications (IDs)). Here, for example, each account corresponds to a company (which can be considered a user); however, it is understood that an account can correspond to one or more individuals or persons (each of which is a given user). In some embodiments, the asset table 300 includes a company table 302, an example of which is also shown in FIG. 3B. In some embodiments, the asset table 300 includes a site table 304, an example of which is also shown in FIG. 3C. In some embodiments, the asset table 300 includes an asset join table 312, an example of which is also shown in FIG. 3D. In some embodiments, the asset table 300 includes a controller join table 316, an example of which is also shown in FIG. 3E. And in some embodiments, the asset table 300 includes a site share join table such as company site share join table 306, an example of which is also shown in FIG. 3F.

The example company table 302 of FIGS. 3A and 3B corresponds the share code 308 (which may be more generically referred to as a code) to the companyId (e.g., the “id” in the company table 302, and which may be more generically referred to unique identifier) assigned to each account. In some embodiments, the share code 308 is a unique user-facing account identifier or code for the company that can be seen and shared between users of the various accounts, whereas the companyId is a unique database or system-facing account identifier or code for the company for use in the database 12. In the example of FIG. 3B, the company table 302 lists three companies ACME Corp., Min Inc., and Joe's Irrigation, each respectively assigned company Ids 1, 2, 3 (e.g., system-facing account identifiers), and share codes xxv-33, 89xx-cc, and 904-dd (e.g., user-facing account identifiers).

In some embodiments, the User table 314 stores relationships between the userId corresponding to the “id” in the User table 314 (e.g., a unique user identifier) and the companyId corresponding to the “id” in the company table 302 (e.g., unique identifier associated with the company). For example, a company can specify one or more individual users associated with the company id.

In some embodiments, the Asset table portion 312 of FIGS. 3A and 3D contains the different asset types (e.g., controller and site, for example) deployed in various irrigation systems known to the server 10 and associated with the company. In some embodiments, the Asset table portion 312 includes the “id” corresponding to the Asset (e.g., AssetId) and type of asset (e.g., controller and site). In some embodiments, if the asset type is a controller, the Asset table portion 312 makes it easy to identify the one or more child tables (e.g., Station table 318, Program table 320, and Sensor table 322) associated with a particular controller (e.g., the controller associated with the “id” in the Controller table 316 shown in FIGS. 3A and 3E).

The Site table 304 of FIG. 3C corresponds the various companies (companyIds) to their assets (sites, e.g., where a site is a collection of one or more assets). In the example of FIG. 3C, the Site table 304 lists 6 sites, the corresponding Company Ids, their Asset Ids and corresponding asset names (Name). Alternatively or in addition, the Site table 304 includes “id” corresponding to the site (e.g., SiteId), AssetId corresponding to the “id” in the Asset table portion 312, and/or Name associated with the site.

The company site share join table 306 of FIGS. 3A and 3F is the portion of the asset table 300 that is updated when one account chooses to share a site with another account. The Company site share join table 306 stores the relationship of assets shared and borrowed, and defines which assets are shared through the SiteId. As shown in the example of FIG. 3F, the owner account (e.g., User 1 in FIGS. 1 and 2) associated with authorizing company Id 1 (ACME Corp.) is sharing Site Id 1 (Site 1) with borrowing company Id 2 (Min Inc.) (e.g., User 2 in FIGS. 1 and 2) for an unspecified duration of time. Also, in the example of FIG. 3F, the owner account associated with authorizing company Id 1 (ACME Corp.) is also sharing Site Id 1 (Site 1) with borrowing company Id 3 (Joe's Irrigation) for a specified duration of time expiring 12-31-2024. And, in the example of FIG. 3F, the owner account associated with authorizing company Id 3 (Joe's Irrigation) is sharing Site Id 4 (Site 4) with borrowing company Id 1 (ACME Corp.) for an unspecified duration of time. It is understood that the authorizing company Id can be referred to more generically as a unique owner identifier, and the borrowing company Id can be referred to more generically as a unique borrower identifier or unique identifier associated with the second account. In an illustrative non-limiting and generic example, the central control irrigation application 13 edits a join table (e.g., the Company site share join table 306) of the Asset table 300 to associate the unique identifier (e.g., a companyId from company table 302 and/or the companyId from company table 302 corresponding to a share code received by an owner associated with the companyId) with the group of the one or more irrigation controllers (e.g., the SiteId) in the Company site share join table 306. In this case and in some embodiments, while the request to change rights provides the user-facing share code (more generically referred to as a code), the Company site share join table 306 is updated with the Company Ids (system-facing identifiers) corresponding to those user-facing share codes.

The Controller table 316 shown in FIGS. 3A and 3E contains or lists controllers (e.g., satellite controllers) deployed in various irrigation systems known to the server 10. In this embodiment, these are the assets having the type corresponding to Controller in the Asset Table 312. In some embodiments, the Controller table 316 includes “id” corresponding to the ControllerId, companyId corresponding to the “id” in the company table 302, AssetId corresponding to the “id” in the Asset table portion 312, and the SiteId corresponding to the “id” in the Site table 304 to indicate to which site they belong. For example, Controller Ids 1 and 2 are both associated with Company Id 1 and Site Id 1. However, Controller Ids 1 and 2 are separately associated with Asset Ids 3 and 5, respectively. Additionally, both Asset Ids 3 and 5 are associated with the asset type “controller” as shown in Asset table portion 312 in FIG. 3D. Moreover, CompanyId 1 is associated with Site 1 Name and Asset Id 1 as shown in Site table 304 in FIG. 3C while Asset Id 1 is associated with the asset type “Site” as shown in Asset Table portion 312 in FIG. 3D. The Controller table 316 does not list assets that do not have controller as the asset type.

Alternatively or in addition, the Asset Table 300 includes a Station table 318, a Program table 320, and/or a Sensor table 322. These tables are child tables below the Controller table 316. In this embodiment, these tables list the assets associated with asset types matching stations, programs and sensors, respectively. For example, one or more of the Station table 318, the Program table 320, and/or the Sensor table 322 store the relationship of each company to their corresponding assets. In some embodiments, one or more of the Station table 318, the Program table 320, and/or the Sensor table 322 include “id” corresponding to the Station table Id, companyId corresponding to the “id” in the company table 302, and/or AssetId corresponding to the “id” in the Asset table portion 312. In some embodiments, if a given share code is used to share a site including a controller listed in the table 316, then stations, programs and sensors of the child tables 318, 320, 322 are also shared with that controller.

In some embodiments, this procedure and system described herein allow users to share their sites without requiring that the users exchange their username and password credentials, or creating copies of the account data that can get out of sync. Borrowing users can access shared sites from their own account and do not need to create specific user accounts every time they have different owners share with them.

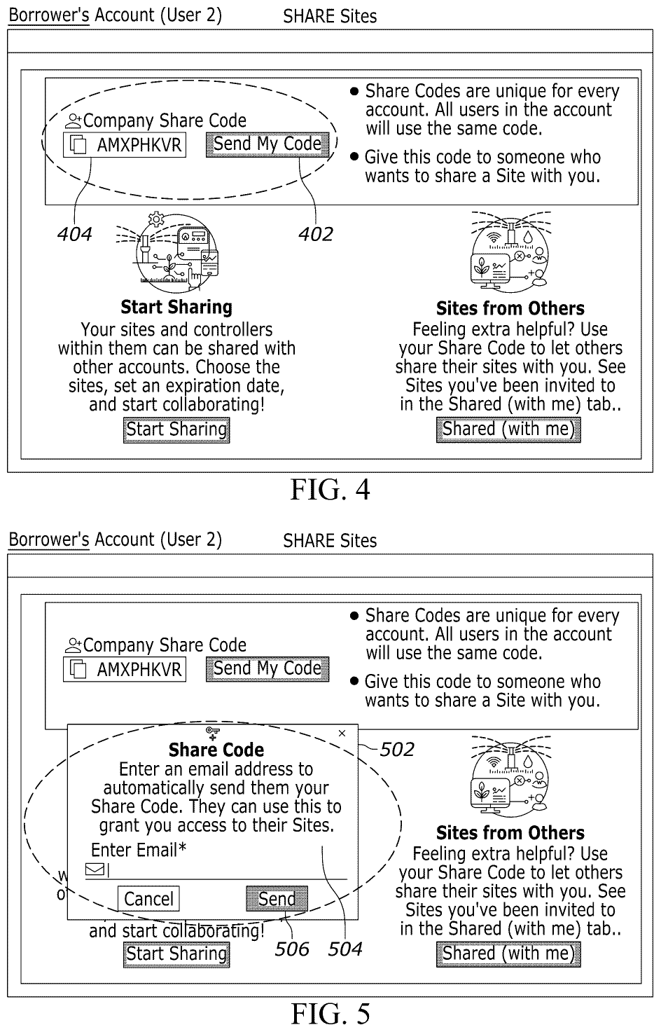

FIGS. 4-8 provide an exemplary user interface (e.g., first user interface 17 and second user interface 18) allowing users to share sites in accordance with some embodiments. In the user interface of FIG. 4 (which the borrowing user's user interface, e.g., User 2 of FIGS. 1 and 2), a user intending to request site/s to be shared with the owner user selects “Send My Code” 402. As can be seen, the borrower's share code (which may be more generically referred to as a code) in this example is AMXPHKVR, which is pre-populated in the share code field 404. Next, the user is prompted (e.g., via menu 502) to enter the email address for the owner in the user interface (via email field or more generic contact initiation field 504) of FIG. 5, causing an email to be sent to the owner (e.g., when the user selects send 506). Alternatively, in some cases, a phone number or other address or identification can be provided to cause a text or notification to be sent to the owner and viewable in their account. The owner will receive the email with the share code from the borrower. It is also noted that in some cases, the borrowing user can provide their share code to the owner through other communication methods independent of the central control irrigation application 13, e.g., separate email, text, written note, printed on a business card, etc.

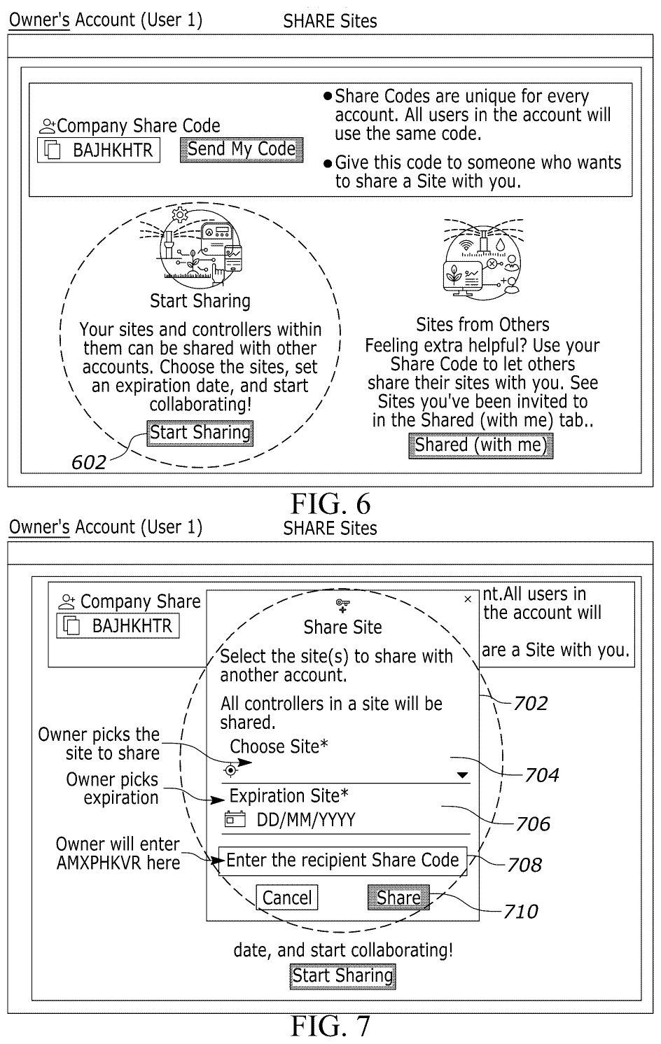

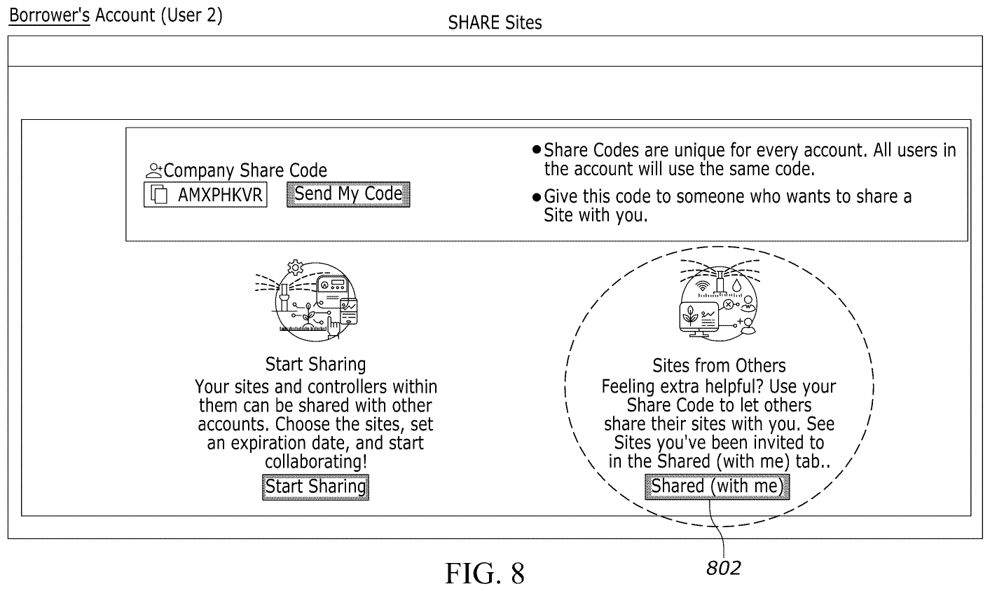

Then in some embodiments, when the owner (e.g., User 1 of FIGS. 1 and 2) logs in their account, the owner selects “Start Sharing” 602 in FIG. 6, and then selects the site (e.g., via a site selection field 704), expiration (e.g., via an expiration field 706) and enters the share code from the borrower (e.g., via a recipient share code field 708) in a site selection menu 702 of FIG. 7. In some embodiments, the user selects Share 710 to enter the selection. FIGS. 6 and 7 show the user interface from the owner's account (e.g., User 1 of FIGS. 1 and 2). And as described above, the irrigation application of the server 10 will update the database (e.g., update the company site share join table 306 of the asset table 300 of FIGS. 3A and 3F with the appropriate company Ids corresponding to the share code, indicating an authorizing company Id and a borrowing company Id) to provide the rights to the borrowing user. Once shared, from the borrower's user interface (e.g., User 2 of FIGS. 1 and 2), the borrower can select “Shared (with me)” 802 to access the shared controller/s in FIG. 8. In some embodiments, the site selection menu 702 can be referred to generically as a change rights request interface displayed to the first user that includes an irrigation site selection field and a code entry field so that the first user can request to change rights for a site (e.g., share a site). When submitted, the request to change rights is sent to the central control irrigation application, which when processed will also allow the second user to access and edit the at least one programming parameter of the group of the one or more irrigation controllers via a second user interface.

### Transferring Sites

In some situations, the owner of a site would like to transfer ownership of the site to another user. For example, an irrigation system installer may use their account to set up a controller at a homeowner's house, and once completed, the installer then transfers the controller in the system to the homeowner's account. In another example, an irrigation installer is under contract to set up a site (group of one or more controllers) for a new community and oversees the grow-in period for 6 months, at the end of which the installer then transfers the site to the irrigation maintenance professional's account. In this case, the ownership of the site is transferred from one user account (one user) to another user account (another user), whereas when a site is shared, the ownership does not change.

In some embodiments, transferring sites also uses the code that is specific to the recipient user, e.g., the share code of the recipient user which may correspond to one or more individuals, a company, and so on. In some embodiments, to initiate, the recipient user sends that user's share code to the current owner, similar to that shown in FIGS. 4-5.

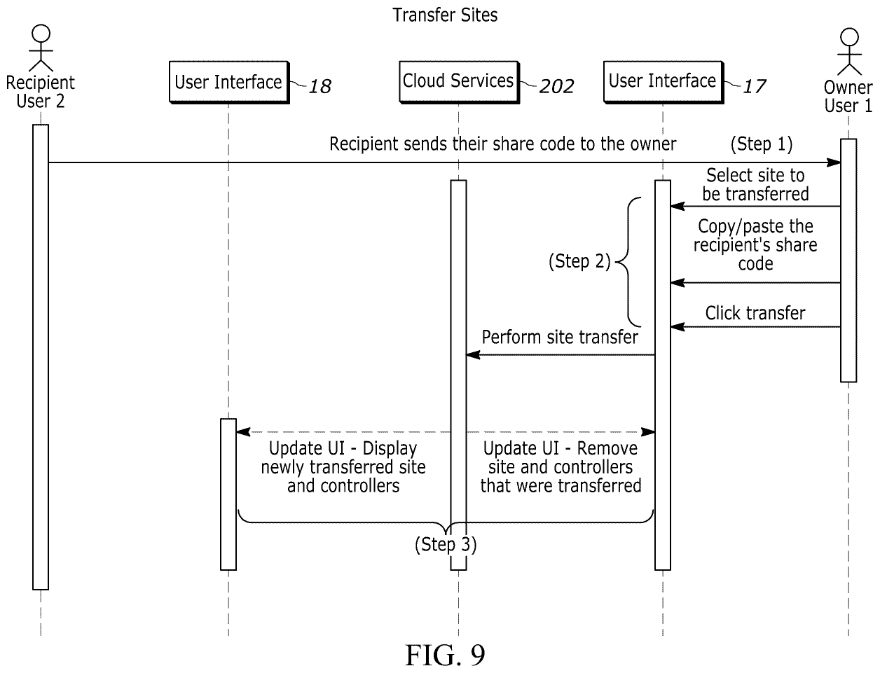

Referring to FIG. 9, in some embodiments, for User 1 (owner) to transfer a site (i.e. group of one or more controllers) to User 2 (borrowing user), User 2 first sends a unique code which is in some cases referred to as a share code (e.g., user-facing numeric, alphabetic, or alphanumeric code corresponding to an account identification, and/or a unique code, to name a few) to User 1 (Step 1). In some cases, User 2 causes an email to be sent to User 1. User 2's unique share code is specific to the account associated with User 2 and is used to identify the user account for User 2 or to identify User 2. When User 1 receives the share code, User 1 determines which site/s to transfer to User 2 and inputs the share code for those site/s to be transferred (Step 2). For example, the central control irrigation application 13 edits the asset table 300 stored in the database 12 to remove a unique owner identifier (e.g., owner company Id) corresponding to the user account for owner (User 1) associated with the group of the one or more irrigation controllers (e.g., irrigation controller 20, irrigation controller 22, irrigation controller 24 of FIG. 1) from the asset table 300, such that the owner (User 1) no longer can access and edit the at least one programming parameter of the group of the one or more irrigation controllers. In some embodiments, the central control irrigation application 13 edits a join table (e.g., edits the site table 304 of FIGS. 3A and 3C) of the asset table 300 to change the unique owner identifier (e.g., owner company Id in the database) that corresponds to the user account associated with the owner (User 1) to a unique new owner identifier (e.g., company Id in the database) that corresponds to the user account associated with new owner or recipient (User 2). In some embodiments, the code includes a share code that is unique to the user account, and the share code corresponds to the unique owner identifier that corresponds to the corresponding user associated with the user account. At this point, the cloud server 10 is updated (database update) and the selected site/s are now transferred to the recipient (User 2), which is shown to the users by updating their respective user interfaces to display the transferred site in the UI for User 2 and remove the transferred site in the UI for User 1 (Step 3). For example, as shown in FIG. 9, the user interfaces (e.g., the first user interface 17 and the second user interface 18) are updated to indicate to User 2 that a site has been transferred and to indicate to User 2 that the site is now transferred to User 2 (Step 3).

In some embodiments, the transferring of sites uses the same asset table 300 of FIG. 3A. For example, to make the ownership change, the “companyId” corresponding to the received share code (per the company table 302 of FIG. 3B) is changed in the site table 304 from that of the original owner to that of the recipient owner. It is noted that the site and its data are not copied from one data location to another, only the companyId is changed in the site table 304. Thus, in some embodiments, to transfer ownership there is no need to provide usernames or passwords. Thus, in some embodiments, when transferring sites, the transferred sites are not copied or cloned. The new owner views and edits the same database objects as did the prior owner.

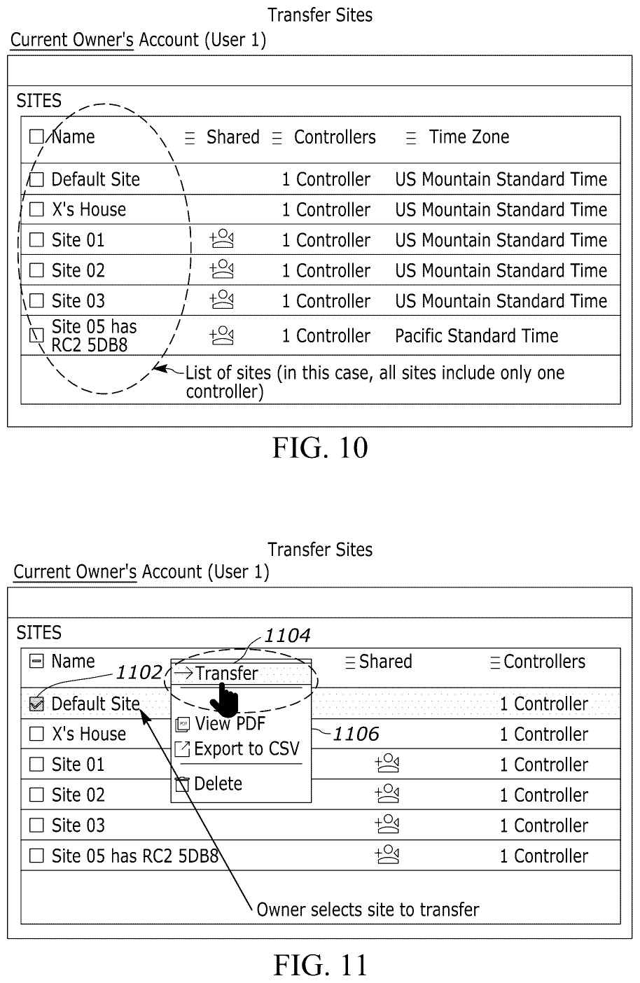

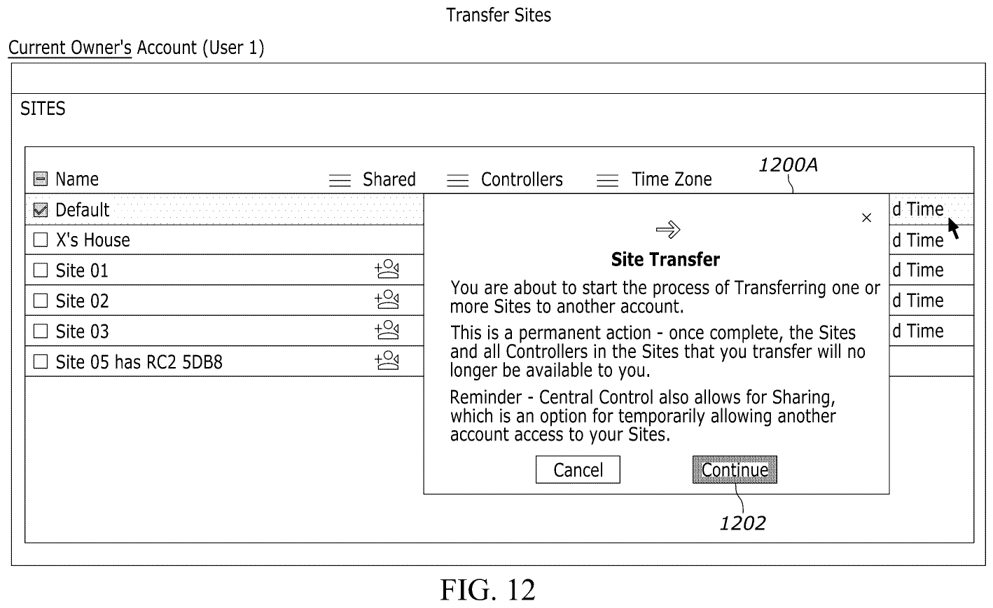

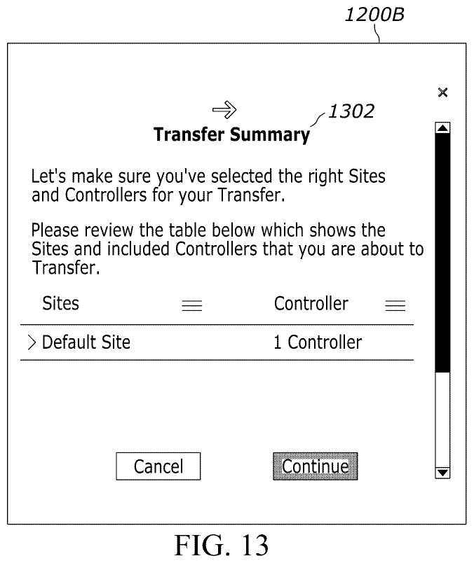

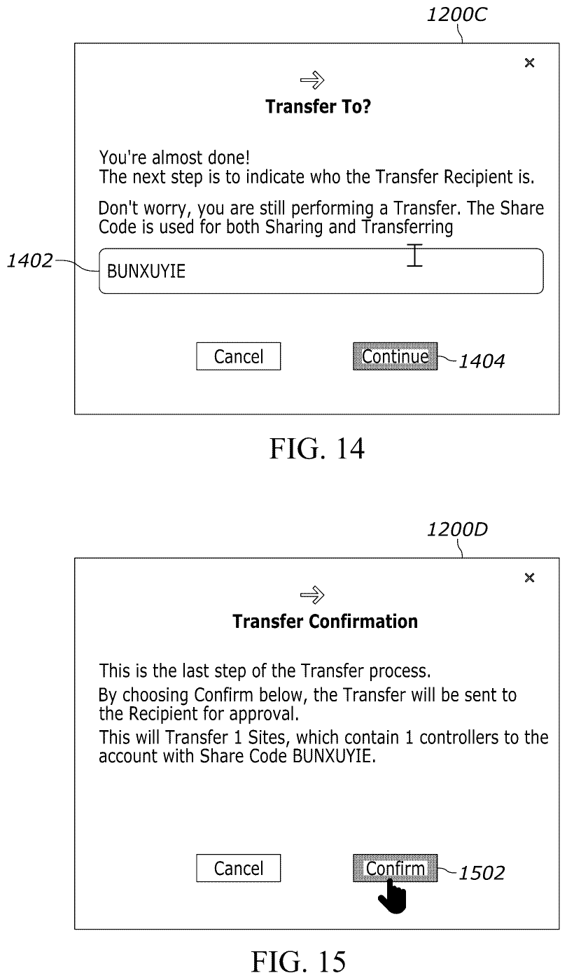

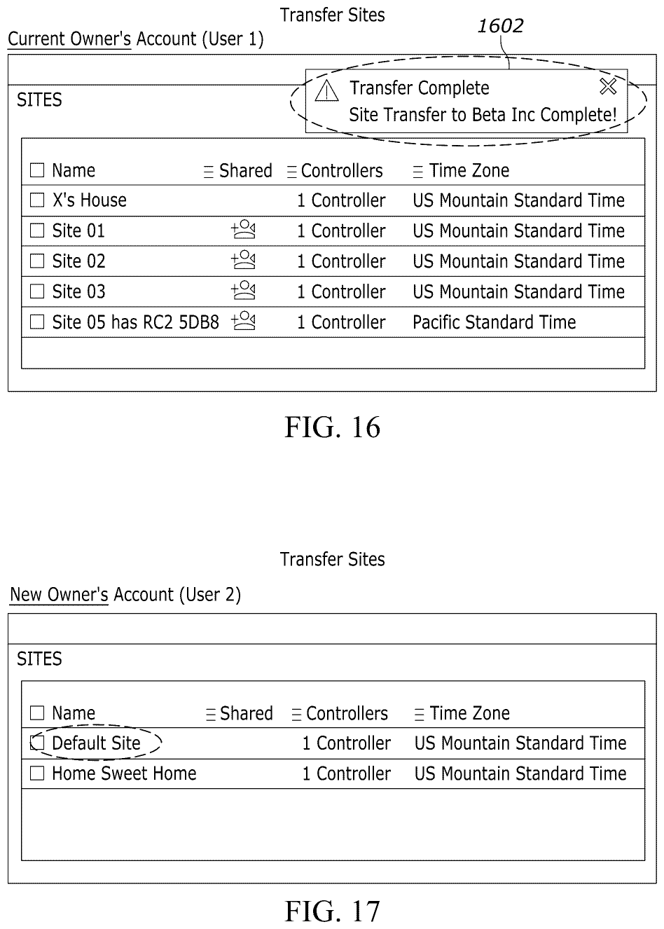

FIGS. 10-17 provide example user interfaces (e.g., first user interface 17 and second user interface 18) illustrating the general process of transferring sites. In some embodiments, from an owner's account (e.g., User 1 of FIGS. 1 and 9), the owner views their sites in a site list in FIG. 10. Here, for example, all listed sites include only one controller, but can include any number of controllers. In FIG. 11, the owner selects a site to transfer, in this case Default Site. For example, the user checks box 1102 next to the site labeled as Default Site, then selects Transfer 1104 in menu 1106. Further it is noted that in these figures, all sites each only include one controller but that it could configured that a given site has multiple controllers (e.g., controllers 20, 22, 24). After selecting transfer in FIG. 11, in some embodiments, the user selects to continue 1202 to the site transfer function in a site transfer menu 1200A of FIG. 12. In some embodiments, FIGS. 13-15 provide a continuation of the site transfer menu 1200 as the user advances through the process. In some embodiments, in FIG. 13, the owner is informed of the transfer of the site in a transfer summary field 1302 of the site transfer menu 1200B. In some embodiments, in FIG. 14, the owner enters the recipient user's (e.g., User 2 of FIGS. 1 and 9) share code (which may be more generically referred to as a code) in the transfer code field 1402 of the site transfer menu 1200C, here BUNXUYIE, and selects to Continue 1404. And in some embodiments, in FIG. 15, the owner confirms the transfer by selecting Confirm 1502 of the site transfer menu 1200D. In some embodiments, in FIG. 16, a notification 1602 is provided confirming the transfer, and the transferred site has now been transferred and is no longer viewable in the original owner's site listing. And now in some embodiments, as shown in FIG. 17, the recipient user (the new owner) (e.g., User 2 of FIGS. 1 and 9) now can see the transferred site in their site listing. In some embodiments, the user selects Share 710 to enter the selection. In some embodiments, the site transfer menu 1200 (menus 1200A-1200D) can be more generically referred to as a change rights request interface displayed to the first user that includes an irrigation site selection field and a code entry field so that the first user can request to change rights for a site (e.g., transfer a site). When submitted, the request to change rights is sent to the central control irrigation application, which when processed will allow the second user (and not the first user) to access and edit the at least one programming parameter of the group of the one or more irrigation controllers via a second user interface.

In some embodiments, a user interface can be implemented in a variety of ways. For example, a user interface may be implemented on a display of a computing device, such as a computer, tablet, mobile phone, and so on. The user interface may be created by an application resident on the computing device and/or created by a browser or other program that renders a user interface in response to instructions from a server (e.g., server 10 of FIG. 1). In some embodiments, user interfaces, such as the first user interface 17 and a second user interface 18, may be visually, audibly, and/or haptically displayed by and/or provided by a computing device.

Computing devices and servers can include control circuits to perform functionality described herein. In some embodiments, a control circuit is a programmable processor (e.g., a microprocessor or a microcontroller). And in some embodiments, the control circuit can comprise a fixed-purpose hard-wired platform or can comprise a partially or wholly programmable platform, such as a microcontroller, an application specification integrated circuit, a field programmable gate array, and so on. In some embodiments, one or more of the control circuits described herein is a general-purpose electronic processor-type device which executes retrieved instructions stored in a separate memory. In some embodiments, one or more of the control circuits described herein is a specific-purpose electronic processor-type device which executes instructions stored in a memory integrated into or coupled to the electronic processor-type device.

A control circuit can be configured (for example, by using corresponding programming stored in the memory (as will be well understood by those skilled in the art) to carry out one or more of the steps, actions, and/or functions described herein. In some embodiments, the memory may be integral to the control circuit or can be physically discrete (in whole or in part) from the control circuit and may be configured to non-transitorily store the computer instructions that, when executed by the control circuit, cause the control circuit to behave as described herein. In some embodiments, a control circuit may be also electrically coupled via a connection to an input/output that can send and/or receive signals to and/or from other devices, for example, the central computer, central cloud server, one or more mobile devices, etc.

User interfaces may be caused to be displayed on various forms of interfaces, such as on a controller display screen with lights and buttons/switches/dials, a mobile device having a touch sensitive display screen and buttons/voice input and running a mobile application, a computer screen of a computer executing an irrigation application and using various user input devices, on a computing device as provided by a server or other central irrigation application transmitting content for display on a computing device or a mobile phone executing an irrigation control application, for example. Further details regarding various user interface displays may be found in one or more of the following patent documents, all incorporated herein by reference: U.S. Pat. No. 10,039,241, granted Aug. 7, 2018, titled PROGRAMMABLE IRRIGATION CONTROLLER HAVING USER INTERFACE (Docket No. 8473-136242-US); and U.S. Application Publication No. 2023/0320295, published Oct. 12, 2023, titled IRRIGATION CONTROL SYSTEMS AND USER INTERFACES, (Docket No. 8473-156623-US).

In some embodiments, the user interfaces such as those described in FIGS. 4-8 and 10-17 can be used to provide a change rights request interface that includes an irrigation site selection field and a code entry field to the first user. In some embodiments, this allows the first user to request to change rights for a site (e.g., share or transfer a site). When submitted, the request to change rights is sent to the central control irrigation application, which when processed will allow the second user (and not the first user if the change is a transfer) to access and edit the at least one programming parameter of the group of the one or more irrigation controllers via a second user interface.

In some embodiments, an irrigation control system comprises an irrigation management application for use in monitoring and/or controlling irrigation of at least one irrigation site including one or more irrigation controllers, wherein the irrigation management application is configured to be executed by an electronic device including a control circuit, and a memory, wherein the irrigation management application is stored in the memory. When executed by the control circuit, the irrigation management application: causes a first user interface to be displayed on a display to a first user associated with a first account registered with a central control irrigation application at a server, the first user interface providing a change rights request interface including an irrigation site selection field and a code entry field to the first user, wherein the at least one irrigation site comprises a group of one or more irrigation controllers associated with the first account and that the first user can access and edit at least one programming parameter of the group of the one or more irrigation controllers via the first user interface, wherein each irrigation controller comprises is coupled to one or more irrigation valves actuatable to control fluid flow to at least one of a plurality of sprinklers; and transmits a request to change rights to the central control irrigation application at the server, the request to change rights including an irrigation site input by the first user to the irrigation site selection field and a code that corresponds to a second account that is also registered with the central control irrigation application and that corresponds to a second user, wherein the request to change rights will allow the second user to access and edit the at least one programming parameter of the group of the one or more irrigation controllers via a second user interface.

And in some embodiments, some embodiments, an irrigation control system comprises a central control irrigation application for use in monitoring and/or controlling irrigation of at least one irrigation site including one or more irrigation controllers, wherein the central control irrigation application is stored in a memory and configured to be executed by a control circuit of a server. When executed by the control circuit, the central control irrigation application: causes a first user interface to be displayed on a display of a first electronic device to a first user associated with a first account registered with the central control irrigation application at the server, the first user interface providing a change rights request interface including an irrigation site selection field and a code entry field to the first user, wherein the at least one irrigation site comprises a group of one or more irrigation controllers associated with the first account and that the first user can access and edit at least one programming parameter of the group of the one or more irrigation controllers via the first user interface, wherein each irrigation controller comprises is coupled to one or more irrigation valves actuatable to control fluid flow to at least one of a plurality of sprinklers; allows the first user interface to transmit a request to change rights to the central control irrigation application at the server, the request to change rights including an irrigation site input by the first user to the irrigation site selection field and a code that corresponds to a second account that is also registered with the central control irrigation application and that corresponds to a second user; and edits an asset table stored in a database to associate a unique identifier (e.g., company Id) associated with the second account and corresponding to the code with the group of the one or more irrigation controllers in the asset table to allow the second user to access and edit the at least one programming parameter of the group of the one or more irrigation controllers via a second user interface.

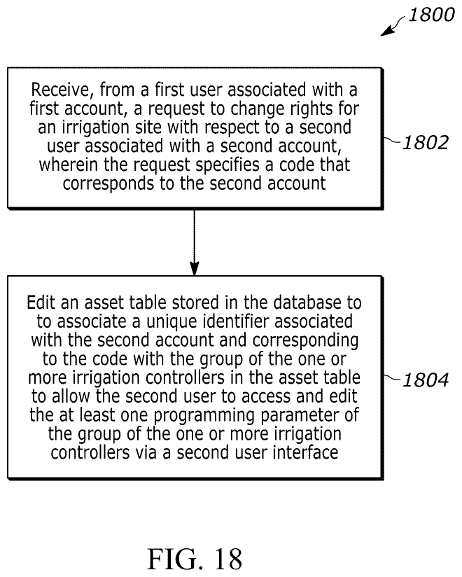

Referring next to FIG. 18, a flow diagram is shown that illustrates methods of sharing and/or transferring irrigation sites in accordance with some embodiments. In some embodiments, the methods of FIG. 18 may be performed by the systems and devices described herein and other systems and devices. A first step is to receive, from a first user associated with a first account, a request to change rights for an irrigation site with respect to a second user associated with a second account (Step 1802). In some embodiments, the first account and the second account are registered with the central control irrigation application. In some embodiments, the request specifies a code (e.g., a share code) that corresponds to the second account. In some embodiments, the irrigation site comprises a group of one or more irrigation controllers associated with the first account and that the first user can access and edit at least one programming parameter of the group of the one or more irrigation controllers via a first user interface. In some embodiments, each irrigation controller comprises is coupled to one or more irrigation valves actuatable to control fluid flow to at least one of the plurality of sprinklers. In some embodiments, the method is performed by a central control irrigation application 13 that manages watering of at least plant life by a plurality of sprinklers at a landscape via irrigation valves and is executed by a control circuit 11 of a server 10.

It is noted that in some embodiments, the request to change the rights is a request to share the irrigation site with the second user, such that the first user and the second user can both access and edit the at least one programming parameter of the group of the one or more irrigation controllers. And in some embodiments, the request to change the rights is a request to transfer the irrigation site to the second user, where the central control irrigation application is configured to edit the asset table stored in the database to remove a unique identifier (e.g., owner customer Id) corresponding to the first account associated with the group of the one or more irrigation controllers from the asset table, such that the first user no longer access and edit the at least one programming parameter of the group of the one or more irrigation controllers.

It is noted that in some embodiments, the request to change rights for an irrigation site may be initiated by either user, and that in some embodiments, e.g., those shown in FIGS. 2 and 9, the request is initiated by the user intending to borrow (or receive ownership of) the irrigation site. In other embodiments, the owning user may initiate the request to change rights, e.g., by specifying the code (e.g., share code) of the user intending to the borrow (or receive ownership of) the irrigation site. In either case and in some embodiments, the central control irrigation application receives, from a first user associated with a first account (e.g., User 1 in FIGS. 2 and 9), a request to change rights for an irrigation site with respect to a second user (e.g., User 2 in FIGS. 2 and 9) associated with a second account.

A next step is to edit an asset table stored in the database associate a unique identifier (e.g., company Id) associated with the second account and corresponding to the code with the group of the one or more irrigation controllers in the asset table (Step 1804). For example, in some embodiments, the central control irrigation application 13 edits an asset table, such as the asset table 300 of FIG. 3A. In some embodiments, this asset table edit allows the second user to access and edit the at least one programming parameter of the group of the one or more irrigation controllers via a second user interface (1806). For example, in some embodiments, commands to edit and/or update irrigation programming are received at the central control irrigation application (e.g., central control irrigation application 13) which consults with the asset table (e.g., with the Company site share table 306 of asset table 300) to determine if the requesting user is authorized to (has access in the asset table) to make this requested change. If so, the central control irrigation application transmits signaling to the designated controller via the network 30.

Further aspects of the disclosure are provided by the subject matter of the following clauses which include references to examples described herein but are not limited to the examples described herein.

An irrigation control system and method of using the system are provided, where the system includes: a server having a control circuit; a database; and a central control irrigation application to manage watering of at least plant life by a plurality of sprinklers at a landscape via irrigation valves and to be executed by a control circuit. And when executed by the control circuit of the server, the central control irrigation application: receives, from a first user associated with a first account, a request to change rights for an irrigation site with respect to a second user associated with a second account, wherein the first account and the second account are registered with the central control irrigation application, wherein the request specifies a code (e.g., a share code) that corresponds to the second account, wherein the irrigation site comprises a group of one or more irrigation controllers associated with the first account and that the first user can access and edit at least one programming parameter of the group of the one or more irrigation controllers via a first user interface, wherein each irrigation controller comprises is coupled to one or more irrigation valves actuatable to control fluid flow to at least one of the plurality of sprinklers; and edits an asset table stored in the database to associate a unique identifier (e.g., company Id) associated with the second account and corresponding to the code with the group of the one or more irrigation controllers in the asset table to allow the second user to access and edit the at least one programming parameter of the group of the one or more irrigation controllers via a second user interface.

The irrigation control system of any preceding clause, wherein the central control irrigation application is configured to edit a join table of the asset table to associate the unique identifier (e.g., company Id) associated with the second account and corresponding to the code with the group of the one or more irrigation controllers in the join table.

The irrigation control system of any preceding clause, wherein the request to change rights comprises a request to share the irrigation site with the second user, such that the first user and the second user can both access and edit the at least one programming parameter of the group of the one or more irrigation controllers.

The irrigation control system of any preceding clause, wherein the request to share the irrigation site with the second user comprises data defining an end of a share period.

The irrigation control system of any preceding clause, wherein the code comprises a share code that is unique to the second account, and the share code corresponds to the unique identifier (e.g., company Id) associated with the second account.

The irrigation control system of any preceding clause, wherein the central control irrigation application edits a site share join table (e.g., Company site share table) of the asset table to associate the unique identifier (e.g., company Id) associated with the second account as a borrower of the group of the one or more irrigation controllers in the site share join table.

The irrigation control system of any preceding clause, wherein the request to change rights comprises a request to transfer the irrigation site to the second user; and wherein the central control irrigation application edits the asset table stored in the database to remove a unique owner identifier (e.g., owner company Id) corresponding to the first account associated with the group of the one or more irrigation controllers from the asset table, such that the first user no longer access and edit the at least one programming parameter of the group of the one or more irrigation controllers.

The irrigation control system of any preceding clause, wherein the central control irrigation application edits a join table of the asset table to change the unique owner identifier (e.g., owner company Id) that corresponds to the first account to the unique identifier (e.g., receiving company Id) associated with the second account and corresponding to the code.

The irrigation control system of any preceding clause, wherein the code comprises a share code that is unique to the second account, and the share code corresponds to the unique identifier (e.g., company Id) associated with the second account and corresponding to the code.

The irrigation control system of any preceding clause, wherein the code (e.g., share code) comprises a series of characters that acts as a user-facing account identifier associated with the second account.

The irrigation control system of any preceding clause, wherein the code corresponds to a system-facing account identifier (e.g., company Id) that corresponds to the second account.

A method for use with an irrigation system includes the steps: receiving, at a central control irrigation application that manages watering of at least plant life by a plurality of sprinklers at a landscape via irrigation valves and is executable by a control circuit of a server, from a first user associated with a first account, a request to change rights for an irrigation site with respect to a second user associated with a second account, wherein the first account and the second account are registered with the central control irrigation application, wherein the request specifies a code (e.g., share code) that corresponds to the second account, wherein the irrigation site comprises a group of one or more irrigation controllers associated with the first account and that the first user can access and edit at least one programming parameter of the group of the one or more irrigation controllers via a first user interface, wherein each irrigation controller comprises is coupled to one or more irrigation valves actuatable to control fluid flow to at least one of the plurality of sprinklers. Alternatively or in addition, the method includes editing, by the central control irrigation application, an asset table stored in a database to associate a unique identifier (e.g., company Id) associated with the second account and corresponding to the code with the group of the one or more irrigation controllers in the asset table to allow, by the central control irrigation application, the second user to access and edit the at least one programming parameter of the group of the one or more irrigation controllers via a second user interface.

The method of any preceding clause, wherein the request to change rights comprises a request to share the irrigation site with the second user, such that the first user and the second user can both access and edit the at least one programming parameter of the group of the one or more irrigation controllers.

The method of any preceding clause, wherein the request to share the irrigation site with the second user comprises data defining an end of a share period

The method of any preceding clause, wherein the request to change rights comprises a request to transfer the irrigation site to the second user, such that the first user can no longer access and edit the at least one programming parameter of the group of the one or more irrigation controllers.

The method of any preceding clause, wherein the code comprises a share code that is unique to the second account, and the share code corresponds to a unique identifier (e.g., company Id) associated with the second account and corresponding to the code.

An irrigation control system comprises an irrigation management application for use in monitoring and/or controlling irrigation of at least one irrigation site including one or more irrigation controllers, wherein the irrigation management application is configured to be executed by an electronic device including a control circuit, and a memory, wherein the irrigation management application is stored in the memory. When executed by the control circuit, the irrigation management application: causes a first user interface to be displayed on a display to a first user associated with a first account registered with a central control irrigation application at a server, the first user interface providing a change rights request interface including an irrigation site selection field and a code entry field to the first user, wherein the at least one irrigation site comprises a group of one or more irrigation controllers associated with the first account and that the first user can access and edit at least one programming parameter of the group of the one or more irrigation controllers via the first user interface, wherein each irrigation controller comprises is coupled to one or more irrigation valves actuatable to control fluid flow to at least one of a plurality of sprinklers; and transmits a request to change rights to the central control irrigation application at the server, the request to change rights including an irrigation site input by the first user to the irrigation site selection field and a code (e.g., share code) that corresponds to a second account that is also registered with the central control irrigation application and that corresponds to a second user, wherein the request to change rights will allow the second user to access and edit the at least one programming parameter of the group of the one or more irrigation controllers via a second user interface.

The irrigation control system of any preceding clause, wherein the request to change rights comprises a request to share the at least one irrigation site with the second user, such that the first user and the second user can both access and edit the at least one programming parameter of the group of the one or more irrigation controllers.

The irrigation control system of any preceding clause, wherein the change rights request interface comprises an expiration field for the first user to define an end of a share period.

The irrigation control system of any preceding clause, wherein the request to change rights comprises a request to transfer the at least one irrigation site to the second user such that the first user can no longer access and edit the at least one programming parameter of the group of the one or more irrigation controllers.

The irrigation control system of any preceding clause, wherein the code comprises a share code that is unique to the second account, and the share code corresponds to a unique account identifier (e.g., company Id) associated with the second account.

An irrigation control system comprises a central control irrigation application for use in monitoring and/or controlling irrigation of at least one irrigation site including one or more irrigation controllers, wherein the central control irrigation application is stored in a memory and configured to be executed by a control circuit of a server. When executed by the control circuit, the central control irrigation application: causes a first user interface to be displayed on a display of a first electronic device to a first user associated with a first account registered with the central control irrigation application at the server, the first user interface providing a change rights request interface including an irrigation site selection field and a code entry field to the first user, wherein the at least one irrigation site comprises a group of one or more irrigation controllers associated with the first account and that the first user can access and edit at least one programming parameter of the group of the one or more irrigation controllers via the first user interface, wherein each irrigation controller comprises is coupled to one or more irrigation valves actuatable to control fluid flow to at least one of a plurality of sprinklers; allows the first user interface to transmit a request to change rights to the central control irrigation application at the server, the request to change rights including an irrigation site input by the first user to the irrigation site selection field and a code (e.g., share code) that corresponds to a second account that is also registered with the central control irrigation application and that corresponds to a second user; and edits an asset table stored in a database to associate a unique identifier (e.g., company Id) associated with the second account and corresponding to the code with the group of the one or more irrigation controllers in the asset table to allow the second user to access and edit the at least one programming parameter of the group of the one or more irrigation controllers via a second user interface.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. An irrigation control system comprising:
a server having a control circuit;
a database; and
a central control irrigation application to manage watering of at least plant life by a plurality of sprinklers at a landscape via irrigation valves and to be executed by the control circuit, wherein when executed control circuit of the server, the central control irrigation application:
receives, from a first user associated with a first account, a request to change rights for an irrigation site with respect to a second user associated with a second account, wherein the first account and the second account are registered with the central control irrigation application, wherein the request specifies a code that corresponds to the second account, wherein the irrigation site comprises a group of one or more irrigation controllers associated with the first account and that the first user can access and edit at least one programming parameter of the group of the one or more irrigation controllers via a first user interface, wherein each irrigation controller comprises is coupled to one or more irrigation valves actuatable to control fluid flow to at least one of the plurality of sprinklers; and
edits an asset table stored in the database to associate a unique identifier associated with the second account and corresponding to the code with the group of the one or more irrigation controllers in the asset table to allow the second user to access and edit the at least one programming parameter of the group of the one or more irrigation controllers via a second user interface.

2. The irrigation control system of claim 1, wherein the central control irrigation application edits a join table of the asset table to associate the unique identifier associated with the second account and corresponding to the code with the group of the one or more irrigation controllers in the join table.

3. The irrigation control system of claim 1, wherein the request to change rights comprises a request to share the irrigation site with the second user, such that the first user and the second user can both access and edit the at least one programming parameter of the group of the one or more irrigation controllers.

4. The irrigation control system of claim 3, wherein the request to share the irrigation site with the second user comprises data defining an end of a share period.

5. The irrigation control system of claim 3, wherein the code comprises a share code that is unique to the second account, and the share code corresponds to the unique identifier associated with the second account.

6. The irrigation control system of claim 3 wherein the central control irrigation application edits a site share join table of the asset table to associate the unique identifier associated with the second account as a borrower of the group of the one or more irrigation controllers in the site share join table.

7. The irrigation control system of claim 1, wherein the request to change rights comprises a request to transfer the irrigation site to the second user; and
wherein the central control irrigation application edits the asset table stored in the database to remove a unique owner identifier corresponding to the first account associated with the group of the one or more irrigation controllers from the asset table, such that the first user no longer access and edit the at least one programming parameter of the group of the one or more irrigation controllers.

8. The irrigation control system of claim 7, wherein the central control irrigation application edits a join table of the asset table to change the unique owner identifier that corresponds to the first account to the unique identifier associated with the second account and corresponding to the code.

9. The irrigation control system of claim 8, wherein the code comprises a share code that is unique to the second account, and the share code corresponds to the unique identifier associated with the second account and corresponding to the code.

10. The irrigation control system of claim 1, wherein the code comprises a series of characters that acts as a user-facing account identifier associated with the second account.

11. The irrigation control system of claim 1, wherein the code corresponds to a system-facing account identifier that corresponds to the second account.

12. A method for use with an irrigation system comprising:
receiving, at a central control irrigation application that manages watering of at least plant life by a plurality of sprinklers at a landscape via irrigation valves and is executable by a control circuit of a server, from a first user associated with a first account, a request to change rights for an irrigation site with respect to a second user associated with a second account, wherein the first account and the second account are registered with the central control irrigation application, wherein the request specifies a code that corresponds to the second account, wherein the irrigation site comprises a group of one or more irrigation controllers associated with the first account and that the first user can access and edit at least one programming parameter of the group of the one or more irrigation controllers via a first user interface, wherein each irrigation controller comprises is coupled to one or more irrigation valves actuatable to control fluid flow to at least one of the plurality of sprinklers;
editing, by the central control irrigation application, an asset table stored in a database to associate a unique identifier associated with the second account and corresponding to the code with the group of the one or more irrigation controllers in the asset table to allow the second user to access and edit the at least one programming parameter of the group of the one or more irrigation controllers via a second user interface.

13. The method of claim 12, wherein the request to change rights comprises a request to share the irrigation site with the second user, such that the first user and the second user can both access and edit the at least one programming parameter of the group of the one or more irrigation controllers.

14. The method of claim 13, wherein the request to share the irrigation site with the second user comprises data defining an end of a share period.

15. The method of claim 12, wherein the request to change rights comprises a request to transfer the irrigation site to the second user, such that the first user can no longer access and edit the at least one programming parameter of the group of the one or more irrigation controllers.

16. The method of claim 12, wherein the code comprises a share code that is unique to the second account, and the share code corresponds to a unique identifier associated with the second account and corresponding to the code.

17. An irrigation control system comprising:
an irrigation management application for use in monitoring and/or controlling irrigation of at least one irrigation site including one or more irrigation controllers, wherein the irrigation management application is configured to be executed by an electronic device including a control circuit, and a memory, wherein the irrigation management application is stored in the memory, and wherein when executed by the control circuit, the irrigation management application:
causes a first user interface to be displayed on a display to a first user associated with a first account registered with a central control irrigation application at a server, the first user interface providing a change rights request interface including an irrigation site selection field and a code entry field to the first user, wherein the at least one irrigation site comprises a group of one or more irrigation controllers associated with the first account and that the first user can access and edit at least one programming parameter of the group of the one or more irrigation controllers via the first user interface, wherein each irrigation controller comprises is coupled to one or more irrigation valves actuatable to control fluid flow to at least one of a plurality of sprinklers; and
transmits a request to change rights to the central control irrigation application at the server, the request to change rights including an irrigation site input by the first user to the irrigation site selection field and a code that corresponds to a second account that is also registered with the central control irrigation application and that corresponds to a second user;
wherein the request to change rights will allow the second user to access and edit the at least one programming parameter of the group of the one or more irrigation controllers via a second user interface.

18. The irrigation control system of claim 17, wherein the request to change rights comprises a request to share the at least one irrigation site with the second user, such that the first user and the second user can both access and edit the at least one programming parameter of the group of the one or more irrigation controllers.

19. The irrigation control system of claim 17, wherein the change rights request interface comprises an expiration field for the first user to define an end of a share period.

20. The irrigation control system of claim 17, wherein the request to change rights comprises a request to transfer the at least one irrigation site to the second user such that the first user can no longer access and edit the at least one programming parameter of the group of the one or more irrigation controllers.

21. The irrigation control system of claim 17, wherein the code comprises a share code that is unique to the second account, and the share code corresponds to a unique account identifier associated with the second account.

22. An irrigation control system comprising:
a central control irrigation application for use in monitoring and/or controlling irrigation of at least one irrigation site including one or more irrigation controllers, wherein the central control irrigation application is stored in a memory and configured to be executed by a control circuit of a server, and wherein when executed by the control circuit, the central control irrigation application:
causes a first user interface to be displayed on a display of a first electronic device to a first user associated with a first account registered with the central control irrigation application at the server, the first user interface providing a change rights request interface including an irrigation site selection field and a code entry field to the first user, wherein the at least one irrigation site comprises a group of one or more irrigation controllers associated with the first account and that the first user can access and edit at least one programming parameter of the group of the one or more irrigation controllers via the first user interface, wherein each irrigation controller comprises is coupled to one or more irrigation valves actuatable to control fluid flow to at least one of a plurality of sprinklers;
allows the first user interface to transmit a request to change rights to the central control irrigation application at the server, the request to change rights including an irrigation site input by the first user to the irrigation site selection field and a code that corresponds to a second account that is also registered with the central control irrigation application and that corresponds to a second user; and
edits an asset table stored in a database to associate a unique identifier associated with the second account and corresponding to the code with the group of the one or more irrigation controllers in the asset table to allow the second user to access and edit the at least one programming parameter of the group of the one or more irrigation controllers via a second user interface.
